(19) United States
(12) Patent Application Publication
(10) Pub. No.: US 2026/0326343 A1
(43) Pub. Date: Oct. 22, 2026

(54) A METHOD FOR PROCESSING CARPET WASTE

(71) Applicant: Aquafil S.p.A., Acro (IT)

(72) Inventors: Luca Bertamini, Acro (IT); Gianmarco Giacomelli, Acro (IT)

(21) Appl. No.: 19/113,066

(22) PCT Filed: Jul. 17, 2023
(86) PCT No.: PCT/EP2023/069766

§ 371 Date: Mar. 19, 2025

(30) Foreign Application Priority Data
Sep. 21, 2022 (WO) PCT/NL2022/050530

(51) Int. Cl. B29B 17/02; B29B 17/04

(52) U.S. Cl. CPC B29B 17/02; B29B 17/0412; B29B 2017/0217; B29B 2017/044

(57) ABSTRACT

A method for processing a carpet product including face yarns and a backing material embedding a lower portion of the face yarns, using an apparatus including a container for receiving at least a portion of the carpet product, the container including at least one rotary crank positioned in the container, with an upright wall having an unravelling arrangement positioned in the circumference of the rotary crank, the unravelling arrangement including protrusions on the upright wall extending into the container from the wall towards the rotary crank, the method including feeding the carpet product into the container, rotating the rotary crank to induce that the carpet product travels along the protrusions for unravelling the carpet product in a first fraction including at least part of the face yarns and a second fraction including at least part of the backing material.

### GENERAL FIELD OF THE INVENTION

The present invention in general pertains to methods for processing carpet product waste to enable recycling of its constituting materials, in particular at least its face yarns and backing material. In particular the invention pertains to the processing of post consumer carpet products, but it does not exclude the processing of newly produced but redundant (and thus unused) carpet products (also called post-industrial waste or pre consumer type).

### BACKGROUND ART OF THE INVENTION

Carpet products, also denoted simply as “carpet”, such as broadloom carpet, carpet tiles, mats, rugs, runners etc, are typically used to cover floors, walls, interiors of cars, planes, boats etc. to provide a comfortable feel and pleasant look. Machine-made carpet products typically comprise a fibrous (textile) sheet as a primary backing with polymer yarns (loosely) connected thereto as a basic constituent, the yarns constituting the face surface of the product. For example, most carpets are produced by stitching (which term includes weaving) the polymer yarns into the primary backing, to provide a pile of the polymer yarns protruding from a top surface of the backing. The yarn is called face fiber and can be inserted with or without cutting it into shorter length. In the latter case the carpet has a loop appearance and the fiber is endless for all the carpet length. In the first case the carpet has a velour appearance and the face fiber has a limited length from some millimeters to some centimeters. The side opposite to the face surface of the carpet is typically provided with a polymer adhesive or other embedding backing material such as a latex, a cross-linkable polymer or a hot melt adhesive or others, to durably bind the yarns to the primary (often textile) backing and at the same time to form a durable carpet backing. Regarding the secondary backing, also called “back coating” or “heavy layer”, such a backing is typically used to improve mechanical properties such as dimensional stability of the carpet. The secondary backing can e.g. be a bituminous layer, a layer of a meltable polymer like PVC, PU, PO, a plastic sheet, a polymer foam or a fibrous sheet comprising polymer yarns (such as a dense felted layer) or a layer of different rubber types, such as, but not limited to, SBR, NBR rubbers.

Carpet products are used everywhere: in homes, offices, cars, planes, schools etc. Used carpet therefore is the source of one of the biggest waste streams in the world. Adequate recycling of carpet products (carpet and parts of carpet) therefore is of the utmost importance to provide new carpet products in a sustainable way. In the art numerous methods for producing carpet aimed at the possibility of recycling thereof have been described.

EP747525 (BASF) describes a recyclable carpet product prepared from a backing comprising protruding tufts (preferably of the same material as the backing), with a carrier of a thermoplastic substrate bound to the backside of the primary backing with hot melt adhesive (HMA). The backing and tufts are made from materials such as nylon, polyolefin and/or polyester and the thermoplastic carrier from materials such as polyolefins, ethylene vinyl acetate (EVA) and/or polyvinyl chloride (PVC). The HMA is applied to the back surface of the primary backing to lock the tufts in place and to act as a buffer between the backing and carrier, so is selected to be compatible with the polymers of the backing and of the carrier. The carpet may be recycled by heating to a temperature sufficient to (re)soften the HMA but below the melting point of the polymers of the tufted backing and carrier substrate so the carpet separates into its two constituent layers.

U.S. Pat. No. 5,538,776 (Hoechst Celanese) describes a recyclable thermoplastic tufted carpet made of a primary backing with tufts and a secondary backing attached to the primary with a layer of a polyester hot melt adhesive. The HMA takes the place of latex adhesive (see col. 2, lines 50 to 51) and the tufts, primary backing, the HMA and secondary backing are made from one type of thermoplastic polymer (preferably polyester). So the carpet can be recycled through known methods, such as processes to recycle polyesters by glycolysis or methanolysis, and/or extrusion, whereby the specific recycling process is determined by the type of polyester.

EP1598476 (Klieverik Heli) describes a method for manufacturing a backing as an intermediate for making a carpet, where the backing does not use a latex to anchor the fibres (yarns) in place. The backing comprises a sheet with piles of thermoplastic fibres stitched through the thickness of the sheet and protruding from its upper surface. The backing is fed (fibre upwards) along a heated roller surface and its underside is pressed against the roller so the fibres will melt. This method provides the advantage that the intermediate backing can be easily recycled as the fibre and backing sheet can be made from the same polymer. There is no incompatible latex penetrated into the fibre piles (see paragraph [003]). However, this method still has some disadvantages. The fibre is still insufficiently strongly anchored to the backing for use in many applications, for example where fibre is subjected to high mechanical loads (e.g. in the interior of cars, trains, planes, offices, shops etc.). Thus in practise to make carpets from the intermediate backings described by Klieverik, it will still be necessary to apply additional (incompatible) adhesive or latex to the underside of the backing and/or extensively impregnate HMA within the carpet piles and backing to provide sufficient adhesion with HMA alone. The presence of such incompatible materials and/or embedded HMA will mean that such carpet products are difficult to recycle.

WO 2012/076348 (Niaga) describes a method for making carpet that improves the anchor strength of the yarn. In this method when the first yarn bearing sheet is pressed against the heated surface, the relative speed of the sheet and surface are adjusted to provide an additional mechanical force between them in the machine direction which spreads the material of the yarn whilst it is still molten resulting in a stronger bond between the first sheet and the yarn. Also, the use of a reactive adhesive is proposed. However, whilst use of reactive adhesive provides a strong bond and can be recycled (unlike the latex) its use leads to a textile product that does not have optimal mechanical properties. A further disadvantage of using a chemically reactive adhesive is that both the components to be joined and the adhesive must carry co-reactive groups. Thus the polymer used to prepare the primary backing and/or tufts is likely to require chemical modification in an additional step as standard commercial polymers may not contain the required functional groups to be suitable for use with reactive adhesives.

WO2014/198731 (DSM IP Assets BV) describes a method of making carpet that is based on the technology as known from WO 2012/076348 (Niaga) with the proviso that a hot melt adhesive is used at the back of the primary backing, typically for bonding the primary backing to a secondary backing to form a laminate. The patent publication recognises (page 22, first two paragraphs) that this opens the route for using the same (chemical) type of polymer for the yarns as well as the adhesive. It is stated that if the melting points of these materials are comparable, the materials can be recycled together and no separation is necessary. However, in a carpet product, the yarns of the fibrous sheet typically have to fulfil completely other demands (high durability, resiliency, stain resistance etc.) than the polymer as used in the adhesive (good glueing properties, and easy to apply at relatively low temperatures). This explains why the polymer as used in the fibres typically has a high molecular weight (Mw over 50,000 g/mol, thus over 5×10⁴ g/mol, or even over 75,000 g/mol) and a melting point in the range of 180-300 °C (typically between 220 and 280 °C). The polymer that is used as an adhesive is a completely different type of polyester. Such an adhesive is a low molecular weight material (Mw below 35,000 g/mol, typically between 15,000 and 30,000 g/mol), and has a melting point in the range of 50-150 °C. The viscosity is typically very low at a temperature of about 100-160 °C to enable applying the adhesive well below the melting temperature of the yarn material. In line with the teachings of WO2014/198731, these materials cannot be recycled together and separation is necessary making the recycling process relatively complex.

In short, although the art describes multiple ways to produce a carpet that can be easily recycled, this means that complicated new production technology has to applied. Also, it does not provide a solution for recycling the millions of square metres of carpet products produced in a traditional way.

Therefore, in the art methods are available for processing carpet waste, which methods aim at separating to the largest possible degree the various constituting materials, in particular the face yarns and the (secondary) backing material. This leads to waste streams of relatively pure materials than can be used as starting materials for new applications.

WO2018/035565 (Collins) provides a method for recycling carpet products involving the promoting of separation of polymer bonded to a substrate by contacting the polymer composite structure with a composition comprising organic solvent which is absorbed within one or both of the polymer and substrate, wherein the composition comprising organic solvent does not dissolve either the polymer or the substrate, and contacting the polymer composite structure with liquid having a temperature higher than the boiling point of the composition comprising organic solvent used in step, and which does not dissolve either the polymer or the substrate, the action of which promotes separation between the polymer and the substrate. The involvement of organic solvents and high temperatures makes the process complex and not disadvantageous form an environmental point of view.

US2017/0305038 (Broadview Group International LLC) discloses a process for recovering various constituting materials from a waste carpet product, the process comprising applying mechanical force to the carpet product to break a bond between an adhesive and a face fiber material of the carpet. Thereafter separating the face fiber material from the adhesive using a centrifugal screening device and recovering, from the carpet product, a low ash fiber product. The method has the disadvantage that the separation between the face yarns and the secondary backing is relatively incomplete and in that the process cannot be run continuously since the sieves need regular cleaning.

US20190233609 (Fraunhofer Gesellschaft) discloses a method for recycling carpet product comprising polyolefin containing waste, by using a solvent with a specific Hansen parameter and contacting this mixture with a liquid filtration aid before separating the polyolefin from the mixture. Again, the use of a solvent is disadvantageous from an environmental point of view and also, the method is only suitable for processing very specific carpet products, viz. those based on polyolefin polymers. Comparable methods are known for example from U.S. Pat. No. 9,284,431.

U.S. Pat. No. 6,752,336 (Johnsonville Acquisition) discloses a method of recovering carpet materials by reducing the carpet product into size-reduced fibers, slurrying the size-reduced fibers in a liquid medium, and then selectively separating the size-reduced fibers in a centrifuge. The method has only a very restricted applicability, viz. for recovering nylon or polyester face fibers from post-industrial and pre-consumer carpet waste.

U.S. Pat. No. 5,535,945 (Shred-Tech Itd) discloses a process for reclaiming part of the polymeric fibers from post-consumer carpet products, which process includes shredding the post-consumer carpet into strips, dismantling the carpet strips to form a mixture of the fibers to be reclaimed and the backing material to be discarded, and then separating a substantial portion of the fibers from the backing material. The carpet strips are dismantled by impacting the strips of carpeting against an anvil structure with hammer elements using a hammermill. The separation into the various constituting materials is relatively incomplete.

EP 3816345 (New Wave by Innovations BV) discloses a process for unravelling waste objects such as flooring material, using a chamber comprising an upright wall provided with sieve openings, and at least two upright shafts, provided with at least an arm extending transversely of the respective axis and into the chamber. The arms rotate, cut a product introduced into the chamber and therewith aim to separate complex materials of which the product is made into pure waste streams. However, the process is not very suitable to process carpet products. Apparently, the embedding of the lower (inner) part of the face yarns by the backing material (where the yarns form loops in the primary backing) restricts a substantial separation of these face yarns form the backing material by the simple “kitchen blender-like” technology of EP 3816345. Another disadvantage of the known method is that the carpet is mostly fragmented but the different components are not significantly separated each one from the other, this being specifically a big problem in case of carpets backed with elastic layers like for dust control carpets or for loop pile carpet tiles where the yarns are substantially endless. Another disadvantage when processing a carpet product, is due to the presence of the sieves through which both short face yarns extracted from the carpets, the glue and small pieces of the backing are removed simultaneously from the chamber and becomes therefore mixed, whereas the sieves need regular cleaning, due to material accumulation. Another disadvantage is that large carpet fragments and bundles of fiber for loop pile carpets are created and cannot be extracted from the sieves. Another disadvantage is therefore that the process cannot be run continuously, but the machine has to be opened each time for the extraction of the resulting mix of materials, with significant impacts on the process costs.

Therefore, there remains a need for an improved process to process a carpet product to try and separate a substantial part of the face yarns form the (secondary) backing material.

### SUMMARY OF THE INVENTION

In order to meet the object of the invention, a method has been devised for processing a carpet product comprising face yarns and a backing material embedding a lower portion of the face yarns, using an apparatus comprising a container for receiving at least a portion of said carpet product, said container comprising a bottom wall and a top wall connected by an upright wall and at least one rotary crank positioned in said container, wherein said upright wall comprises an unravelling arrangement positioned in the circumference of said rotary crank, the unravelling arrangement comprising protrusions provided on said upright wall extending into the inside of said container from said wall towards said at least one rotary crank, the method comprising feeding the at least portion of said carpet product into the container, and rotating the rotary crank to induce that the carpet product travels along the protrusions for unravelling said carpet product in a first fraction comprising at least part of the face yarns and a second fraction comprising at least part of the backing material.

Surprisingly, it was found that by adding an unravelling arrangement comprising protrusions, provided on an upright wall of the container of the device as disclosed in EP 3816345, a carpet product can be processed to lead to a substantial separation of the face yarns form the heavy backing material. Apparently, in the case of a carpet product the unravelling action in between the two rotary cranks as known from EP 3816345 is very poor. By adding the protrusions, a very good unravelling action is induced around the circumference of the cranks, in particular in the space between the protrusions and the distal end of the cranks (typically provided with a knife or knife-like arrangement). A concomitant advantage is that only one crank is needed for the unravelling action, which means that a less complicated device can be built. To find that a less complicated device is able to more effectively process a more complicated material was highly surprising.

### Definitions

A carpet product is a product comprising as basic constituents a primary backing, typically fibrous of nature, in which primary backing face yarns are stitched (i.e. tufted, woven or by any other means) to mechanically connect the face yarns to the primary backing, wherein the lower (inner) ends of the face yarns at the site where they are connected to the primary backing (thus opposite to the outer visible surface of the carpet) are embedded in a secondary backing (in the art typically referred to as “the backing”) to durably secure the face yarns to the carpet product. The backing often consists of a heavy durable material such as a bituminous layer, a rubber layer, a thermoplastic polymer or a layer in the form of a foam, or a textile material impregnated with an adhesive.

A cut pile carpet product is a carpet product wherein the pile yarns are cut at the top surface, such that the yarns in fact form a loop at the backing, end two cut of ends at the upper surface of the carpet.

A protrusion is an extension beyond the normal surface, suggesting a thrusting or projection out of the surface so that the extension seems a deformity of the underlying surface as such.

A cutting edge is a sharp edge that is suitable for cutting a material by forcing the material to travel along the cutting edge in contact. Typically the sharp edge has an acute angle (thus 90° or below), preferably below 90, 80, 70, 60, 50, 40, 30, 20 or less. The BESS (Brubacher Edge Sharpness Scale) value is preferably below 2000 gram, preferably below 1000 or even below 500 gram.

A process that is performed semi-continuously means that the process is designed to be run in principle continuously, so no interruptions are needed to continuously run the process, but the process may be stopped or interrupted for e.g. maintenance, repair or voluntary interruption due to for example lack of input material or sufficient end material being produced.

### Further Embodiments of the Invention

In a first further embodiment of the method of the invention the wall is impermeable for the first fraction at least adjacent the rotary crank. In EP 3816345 sieves are applied at the height of the cranks, through which sieves a light fraction of a product to be processed is to be removed from the chamber. In case of processing a carpet material however, it was found that there is a severe risk that small parts of the heavy backing also travel through these sieves and thus contaminate the light (yarn) fraction. A solution could be to use sieves with a smaller mesh size, but at the level where backing material no longer passes the sieves, the risk of the sieves clogging due to a build up of yarn material at the front of the sieves is high. This means the process has to be regularly interrupted to clean the sieves. This can be prevented in the current embodiment. By removing the yarn fraction at a higher level in the chamber, thus no longer through sieves at the height of the crank, the risk of parts of the backing travelling with the light fraction is low or even Nil, and thus, an arrangement can be used that is less prone to clogging (such as a sieve with a larger mesh size, or a simple vacuum tube, etc.). Preferably, the complete upright wall is impermeable for the first fraction, thus all sieves (in the wall) are dispensed with.

This completely solves the issue with sieves clogging and/or parts of the backing contaminating the yarn fraction.

In an embodiment the protrusions extend into the container over a length of between 2 and 40 mm, preferably between 5 and 30 mm, such as for example between 10 and 20 mm. Although longer protrusions may be used, for example up to a length of 20 or even 30 cm, such as 5, 6, 7, 8, 9 10, 11, 12, 13, 14, 15, 16, 17, 18, 19, 20, 21, 22, 23, 24, 25, 26, 27, 28, 29, or 30 cm, a length of between 2 and 40 mm has been found ideally suitable for the processing of carpet products.

In yet another embodiment of the method according to the invention, the first fraction is removed from the container by using a first suction unit having an entrance opening that is provided above the rotary crank, by sucking air comprising the first fraction through the entrance opening of the first suction unit, thereby removing the first fraction from the container. By using a simply suction unit, such as a suction tube above the rotary crank, the first fraction remains (almost entirely) clean of parts of the secondary backing which due to their typical weight remain at the bottom of the container, i.e. if the turbulence is kept to a low level by preventing that the cranks rotate at a very high speed. The critical speed of the cranks depends on the type of carpet product (a heavier backing allows higher speeds to be used) and can be found easily by routine experimentation. In a further embodiment the entrance opening of the suction unit is at the end of a suction tube that extends from a wall of the chamber towards the centre thereof. This minimises the risk that part of the secondary backing contaminates the yarn fraction and minimises the need of controlling the speed of the cranks to adjust air turbulences.

Correspondingly, the second fraction is removed from the container by using a second suction unit having an entrance opening below the rotary crank, by sucking air comprising the second fraction through the entrance opening of the second suction unit, thereby removing the second fraction from the container. In the prior art (EP 3816345) the heavy fraction, if not possible from the sieves, must be removed from the top of the container by a suction tube. This means that a very heavy turbulence is needed in the container, otherwise the heavy fraction will not travel to the top section of the chamber. Heavy turbulence however leads to a potential mixing of the different fractions which is disadvantageous for the ease of recycling. By having an arrangement by which the parts of the backing can be removed from the bottom, far less turbulence is needed and thus, there is less risk of mixing the various fractions. Also, there is no longer a need for intermittently cleaning the bottom of the container, and thus, the process could be run semi-continuously.

In still a further embodiment the protrusions comprise a cutting arrangement, in particular a cutting edge, and the carpet product is unravelled by cutting the carpet product while travelling along the cutting arrangement. Although a blunt protrusion will also lead to an unravel action of a carpet product, it was found that a cutting arrangement, in particular a cutting edge, is favourable for increasing the efficiency of the process significantly.

In again another embodiment the said protrusions are arranged in a row, perpendicular to the circumference direction of said container, in a row parallel to the circumference direction of said container, both perpendicular and parallel to the circumference, and/or inclined to the circumference, and optional, wherein said protrusions are arranged equidistant from each other.

In yet again another embodiment the said unravelling arrangement is provided in said upright wall at a height of said upright wall, at least substantially, between ¼ and ¾ of the height of said upright wall, preferably, at least substantially, between ⅓ and ⅔ of the height of said upright wall.

Preferably, while rotating the rotary crank passes the protrusions at a distance in the range of between 0.5 cm and 25 cm, for example between 1 cm and 20 cm or 1 and 10 cm, or between 2 cm and 5 cm. Above 25 cm the unravelling efficiency decreases to a level that disfavours economic use of the process. Below 0.5 cm, the carpet product needs to be shred to very tiny pieces before entering the chamber to prevent that the cranks block. Shredding to small pieces is energetically unfavourable and also, introduces the risk of overheating (and partly melting) the carpet product.

In an embodiment the rotary crank is in essence flat to minimise turbulence at the bottom of the container, to avoid mixing of the different parts of the unravelled carpet. Flat in this sense means that the height (or thickness) is less than 15% of the highest length and width dimension (which length and width extend in a 2D plane), preferably less than 14, 13, 12, 11, 10, 9, 8, 7, 6, 5, 4, 3, 2 or 1%.

In another embodiment, in the container two rotary cranks are positioned that are rotated in the same plane. It was found that by having two rotary cranks in the same plane, the cranks can be used to shred the carpet product into smaller pieces. This way a shredding action, if needed, can take place in whole or for a substantial part in the container itself, instead of at a remote processing station before the product is fed to the container. Preferably the rotary cranks rotate in the same direction. The latter appeared to lead to an improved shredding action.

In still again another embodiment of the method according to the invention, each protrusion in essence has the same distance to the rotary crank facing the said protrusion.

Preferably, the process is performed semi-continuously, thus in essence continuously feeding a carpet product into the chamber (e.g. pieces of a broadloom carpet, or of mats, runners etc), and continuously removing the first and second fractions from the chamber, whereas the second fraction could be removed also in defined periods of time only.

Although the method may still be effective at high humidity percentages such as 50, 60, 70 w % or even higher percentages, it was found that it is advantageous that the carpet product is fed while having a humidity of at most 40 wt %, such as for example 35, 30, 25, 24, 23, 22, 21, 20, 19, 18, 17, 16, 15, 14, 13, 12, 11, 10, 9, 8, 7, 6, 5, 4, 3, 2, 1 wt % or less.

In an embodiment, the carpet product is fed having a longest dimension of at most 50 cm, preferably at most 40, 30, 25, 20, 15, 14, 13, 12, 11, 10 or less cm.

In yet another embodiment, the carpet product is a cut pile carpet product. It was found that the present method is ideally suitable for processing a cut pile carpet, thus a carpet wherein the face yarns are cut, and not endless as is the case in woven carpets.

Further aspects of a method and apparatus to process carpet products, are described in the present application as follows.

As stated here above, a method and arrangement for processing waste objects in general is known from EP 3816345. The arrangement comprises a chamber comprising an upright wall, wherein the upright wall is provided with a plurality of sieve sections. The sieve sections are distributed over the upright wall and disposed at an inclination angle with respect to the circumference direction of the chamber. The arrangement furthermore comprises at least two rotary arms positioned in a lower part of the chamber. A portion of waste objects, comprising a plurality of materials, is ripped apart by subjecting the portion of waste objects in between the at least two rotary arms. The ripped portion of waste objects are slung, by the at least two rotary arms, against the plurality of sieve sections, for separating a first stream from the ripped portion of waste objects, wherein the first stream comprises a first material of the plurality of materials.

The arrangement for processing waste objects, known from the state of the art, may be further optimized by improving the separation of a first material from a plurality of materials, to further decrease a residual stream of first material which is not separated from the plurality of material, and which remains at the inside of the chamber, and needs to be abducted. This leads to non-separable waste, that for example needs to be burned or gathered at waste deposits. Therefore, there is a need for an improved method and apparatus for processing waste objects, and more in particular, it is one of the objects of the present invention to provide for an improved method and apparatus for processing waste objects, for reducing the non-separated waste in apparatus for processing waste objects.

In a first further aspect, an apparatus for processing waste objects is disclosed, wherein said waste objects comprise a plurality of materials, said apparatus comprising: a container, for receiving a portion of said waste objects, said container comprises an upright wall, wherein said upright wall comprises a sieve arrangement and an unravelling arrangement; at least two rotary cranks positioned in a lower part of said container, adjacent to each other and arranged for rotating in a mutual rotational plane, for ripping apart said portion of said waste objects into a ripped portion of waste objects, by subjecting said portion of said waste objects in between said at least two rotary cranks, wherein said unravelling arrangement is positioned in the circumference of said rotary cranks, for unravelling said ripped portion of waste objects into an unravelled ripped portion of waste objects, said unravelling arrangement comprising: protrusions arranged in a pattern on said upright wall and extending into the inside of said container, for unravelling said ripped portion of waste objects, wherein said sieve arrangement is positioned in the circumference of said rotary cranks, said sieve arrangement comprising a plurality of sieve sections, wherein said sieve sections are distributed over said upright wall and disposed at an inclination angle with respect to the circumference direction of said container, arranged for separating a first stream from said unravelled ripped portion of waste objects, said first stream comprising a first material of said plurality of materials, by slinging, by said at least two rotary cranks, said unravelled ripped portion of waste objects against said plurality of sieve sections.

The waste objects processed by the apparatus according the present disclosure may comprise a plurality of materials. The apparatus may thus be arranged for processing a chemical composition of the plurality of materials which can be identical or different, differ in density, differ in specific weight, and/or differ in surface/weight ratio. for example, two or more of the plurality of materials comprise mutually attached components. For example, the apparatus may be arranged or configured for the processing of multi-layer waste objects. An example of this are laminates. A waste object is for example composed of one or more layers selected from plastic foil, rubber, foam, cellulose fibers and/or textile. In a further example, the first material of the plurality of materials comprise fibers, wherein the fibers are synthetic fibers, like polyethylene fibers, and/or natural fibers, like paper, cotton, hemp or jute. Furthermore, the plurality of materials can comprise materials of low specific weight and a stream of components of high specific weight. Components of height specific weight, typically comprising hard plastics (PVC) and/or rubber. Components of low specific weight, typically comprising plastic foils such as polyethylene or polyethylene terephthalate foils. Additionally, the waste objects can comprise impurities, typically of high specific weight, such as stones and/or metal components.

The container comprises a bottom in the lower part of the container, for receiving a portion of the waste objects, an upright wall, and an upper part, which is either open or closable by a cover. From a top view, the container may be hexagonally shaped and/or made of steel.

The upright wall of the container may comprise a sieve arrangement, comprising a plurality of sieve sections, next to the unravelling arrangement that comprises a plurality of unravelling sections. In an embodiment, the upright wall comprises wall sections, wherein the wall sections are removably connected to the upright wall, each wall section comprising a sieve section and/or an unravelling section. In particular, each wall section comprises a steel plate, on or into which the sieve section and/or an unravelling section is received. The size of the wall section is typically, but not limited to, 200×200 mm.

The rotary cranks, in particular one, two or three rotary cranks, are positioned in the lower part of the container. The rotary cranks are positioned adjacent to each other and are arranged for rotating in a mutual rotational plane, at least substantially, parallel to the bottom of the container. Each rotary crank is rotatably connected to an upright shaft, wherein each upright shaft extends into the container, at least substantially, parallel to the upright wall. The rotary cranks extend transversely to the respective upright shaft and into the container.

A set of two (or more) rotary cranks is arranged for ripping apart the portion of the waste objects into a ripped portion of waste objects, by subjecting the portion of the waste objects in between the at least two rotary cranks. A pair of two rotary cranks rip apart large components and friction created in between the rotary cranks rip apart various mutual attached components, such as a plurality of materials comprising fibers mutually attached to other materials, wherein the other materials comprise materials of low specific weight, such as plastic foil, and high specific weight, such as rubber.

Preferably, each rotary cranks comprise a fixed crank element and disposable shredding tips or shredding knives. The shredding tips are preferably configurable in position on the crank such that the mutual distance between the free ends of the tips of two neighboring rotary cranks can be set in the range between 1 cm and 10 cm, and preferably between 1 cm and 5 cm, whereas in the preferred configuration, the mutual distance is set at approximately 5 cm.

Furthermore, during the process of processing waste objects, large components of mutually attached materials are ripped apart into smaller components. The longer the components of mutually attached materials are subjected in between the at least two rotary cranks, the smaller the size of the components, wherein during the ripping apart, the first material, such as fibers, is separated from the plurality of materials.

It was the insight of the inventor to provide an additional unravelling arrangement to the apparatus, positioned in the circumference of the rotary cranks, and comprising protrusions arranged in a pattern on the upright wall and extending into the inside of the container, for unravelling the ripped portion of waste objects into an unraveled ripped portion of waste objects. The unravelling arrangement is arranged for generating friction to the ripped portion of waste objects, for unravelling the ripped portion of waste objects, by slinging, by the at least two rotary cranks, the ripped portion of waste objects against the protrusions. The protrusions extend into the inside of the container, such as, but no limited to, for example in the range between 5 mm and 30 mm.

The main function of the unravelling arrangement is to further unravel the components of mutually attached materials into smaller components of mutually attached materials, and/or to further unravel the components of mutually attached materials, for separating the first material from the plurality of materials, during the process of processing waste objects. The insight created was that the process of processing waste objects is far more efficient by applying an unravelling arrangement, for additionally unravelling the ripped portion of waste objects, in addition to the rotary cranks, for ripping apart the portion of the waste objects. An advantage of the apparatus according to the present invention is that the first material is separated more effectively and efficiently from the plurality of materials, in comparison to arrangements known from the state of the art, leading to less residual non-separable waste, that needs to be burned or gathered at waste deposits.

A further advantage of the apparatus is that energy transferred from the rotary cranks to the material is smaller than in arrangements known from the state of the art. Advantageously, less power is required for driving the rotary cranks and less heat, generated by friction, is generated inside the container, in comparison to arrangements known from the state of the art. This results in a more energy efficient arrangement, less deterioration due the heat generated inside the container, and a more fireproof process of processing waste objects.

The sieve arrangement may be positioned in the circumference of the rotary cranks. The sieve sections of the sieve arrangement are distributed over the upright wall and disposed at an inclination angle of preferably at most 5 degrees, with respect to the circumference direction of the container.

Due to the rotation of the rotary cranks, an airflow is generated in the circumference of the rotary cranks, defining an airflow direction inside the container. Each sieve section comprises a downstream part, downstream to the airflow direction, and an upstream part, upstream to the airflow direction, wherein the downstream edge of the respective sieve section extends more into the inside of the container than the upstream edge of the respective sieve section. This reduces the risk that material will get caught in a sieve section and/or that material will get accumulated in the sieve section.

The first material, such as fibers, may be slung through the sieves of the sieve arrangement and collected outside the container, thereby separating a first stream of first material from the unravelled ripped portion of waste objects. The remaining materials of the plurality of materials, comprising materials of low specific weight and materials of high specific weight, remain in the inside of the container. Impurities in the waste objects, typically of high specific weight, also remain in the inside of the container.

In an example, the least two cranks are arranged for generating a thermal turbulence for separating further materials from said plurality of materials into a second stream of materials of low specific weight and a third stream of materials of high specific weight. Advantageously, the third stream of materials of high specific weight can be collected at, and removed from, the bottom of the container. By dispersing the remaining materials of the plurality of materials by turbulence generated by the at least two rotary cranks, the second stream of materials of low specific weight will swirl up in the container and can be collected at, and removed from, the upper part of the container.

In an example, said protrusions comprise a rod, extending into the inside of said container. The rod, preferably made of metal, is fixed or removably attached to the unravelling section, and extends, at least substantially, perpendicular to the upright wall into inside of the container in the range between for example 15 mm and 30 mm. For example, the rod is cylindrically shaped. In another example, said protrusions comprise a welded protrusion, extending into the inside of said container. The welded protrusion is adapted for roughening the surface of the sieve section at the inside of the container, extends into the inside of the container in the range between for example 5 mm and 15 mm.

In an example, said protrusions comprise a cutting arrangement. For example, the protrusion is one of a knife with a cutting edge or blade, extending into the inside of the container and a rod extending into the inside of the container, wherein at least one longitudinal edge of the protrusion comprises a cutting edge or blade, wherein the cutting edge or blade is arranged for receiving the ripped portion of waste objects and wherein the cutting edge or blade is directed upstream the airflow direction, for unravelling the ripped portion of waste objects by cutting the ripped portion of waste objects into smaller components. This is specifically beneficial for example for unravelling large components of high density comprised in the waste objects, for example shoes, in particular safety shoes with steel toe caps, into smaller components.

In an example, said protrusions are arranged in a row, perpendicular to the circumference direction of said container, in a row parallel to the circumference direction of said container, or both, and optional, wherein said protrusions are arranged equidistant from each other.

In a further example, said unravelling arrangement comprising a plurality of unravelling sections, wherein said protrusions are removably connected to said plurality of unravelling sections and/or wherein a length of said protrusions is adjustable. This may be beneficial, as the unravelling arrangement is adjustable for different types of waste objects, thereby adjusting the amount of friction to the ripped portion of waste objects, wherein the number of protrusions of a respective unravelling section can be adjusted, the protrusions of a respective unravelling section can be arranged in different patterns, for example arranged in a row or in matrix, the distance between subsequent protrusions can be adjusted, and/or the length of individual protrusions can be adjusted.

In an example, the sieve sections and the unravelling sections can be provided in said upright wall at different locations and/or at different heights at said upright wall. The unravelling arrangement may for example be provided in the corners of the container, for example in the corners of the hexagonal shaped container.

In an example, a sieve arrangement is provided in said upright wall at a height of said upright wall, at least substantially, between ¼ and ¾ of the height of said upright wall, preferably, at least substantially, between ⅓ and ⅔ of the height of said upright wall, and/or said unravelling arrangement is provided in said upright wall at a height of said upright wall, at least substantially, between ¼ and ¾ of the height of said upright wall, preferably, at least substantially, between ⅓ and ⅔ of the height of said upright wall. In an example, said sieve has a mesh diameter in the range of between approximately 1 mm and 20 mm, for example between approximately 2 mm and 12 mm, such as between approximately 2 mm and 6 mm, such as for example approximately 2 mm.

In an example, when having multiple cranks, two of these rotary cranks are positioned at a mutual distance such that said at least two rotary cranks pass at a distance in the range of between approximately 1 cm and 25 cm, preferably between approximately 2 cm and 20 cm, more preferably between approximately 3 cm and 15 cm, and most preferably between approximately 5 cm and 10 cm. This is advantageous for effectively ripping apart the portion of waste objects.

In an example, said rotary cranks have a rotary frequency of in the range of between approximately 100 rpm and 3000 rpm, such as between approximately 400 rpm and 1600 rpm, in particular between approximately 800 rpm and 1200 rpm, such as for example at 900 rpm. This is advantageous for effectively ripping apart the portion of waste objects and/or for generating a turbulence by said cranks, for separating further materials of low specific weight from said plurality of materials.

In an example, at least one upright air guiding element is provided inside said container, for defining in cooperation with said upright wall a passage for air along said upright wall, which passage tapers in a airflow direction, wherein the airflow direction is defined as the direction of the airflow in the circumference of said at least two rotary cranks, generated by said at least two rotary cranks. The at least one upright air guiding element is provided outside the rotational volumes of the at least two rotary cranks and is at least partly higher than the rotational volumes of the at least two rotary cranks. The at least one upright air guiding element defines in cooperation with the upright wall a passage for air along the upright wall, which passage tapers in the flow direction. This is advantageous for guiding the ripped portion of waste objects towards the sieve arrangement and/or the unravelling arrangement and/or for guiding the unravelled ripped portion of waste objects towards the sieve arrangement and/or the unravelling arrangement.

In an example, said apparatus further comprising at least one motor for driving said at least two rotary cranks, and a power supply for powering said at least one motor. The apparatus can comprise one motor for driving each rotary crank separately.

Preferably, the apparatus comprises one motor for driving at least two rotary cranks, which is advantageous for the power consumption of the apparatus.

In an example, said apparatus further comprising an air pump for generating an airflow for removing said stream of components of low specific weight from said container. The components of low specific weight swirl up in the container, and can advantageously be removed from the upper part of the container by the air pump. In an example, said portion of said waste objects having a humidity of at most 40 wt %. The process of processing waste objects is most effective for waste objects having a humidity of at most 40 wt %. If the humidity is above 40 wt %, waste object will accumulate inside the container, in particular against and around de sieve sections and the unravelling sections, which is undesirable. If the initial humidity of the waste objects is above 40 wt %, then additional drying processes steps may be initiated, for example through heating, centrifuging, wringing or rolling. If the humidity of the waste objects is below 40 wt %, then water may be added to control and maintain the humidity at a constant level, for example by a spray nozzle inside the container.

In a second further aspect, a method for processing waste objects is disclosed, said method comprising the steps of:
providing said portion of said waste objects to said container;
ripping apart said portion of said waste objects into a ripped portion of waste objects, by subjecting said at least portion in between said at least two rotary cranks;
unravelling said ripped portion of waste objects into said unravelled ripped portion of waste objects, by said unravelling arrangement;
separating a first stream from said unravelled ripped portion of waste, said first stream comprising a first material of said plurality of materials, by slinging said unravelled and ripped portion of waste objects against said plurality of sieve arrangements.

In an example, the method further comprising the step of:
separating further materials from said plurality of materials into a second stream of materials of low specific weight and a third stream of materials of high specific weight, by generating a thermal turbulence by said at least two cranks.

Embodiments of the method according to the present invention will now be explained with reference to the following figures and example.

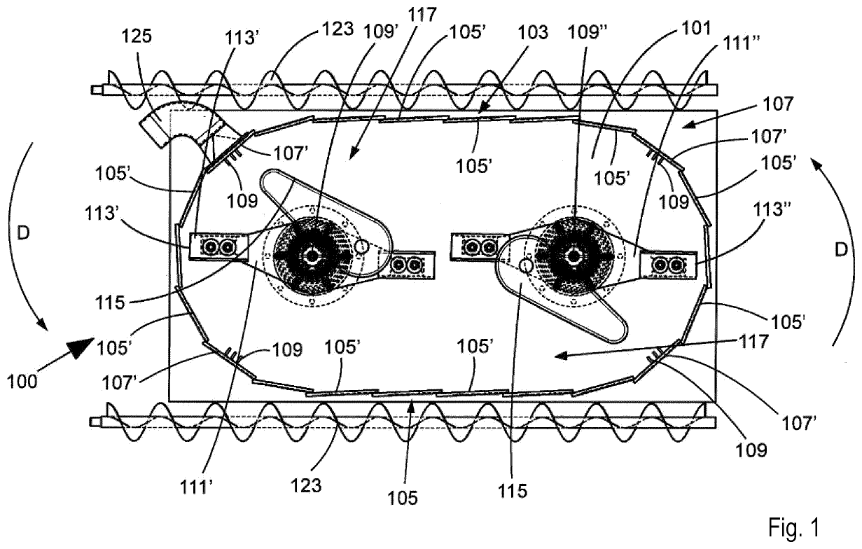

FIG. 1 shows a top view of an embodiment of an apparatus for processing carpet waste.

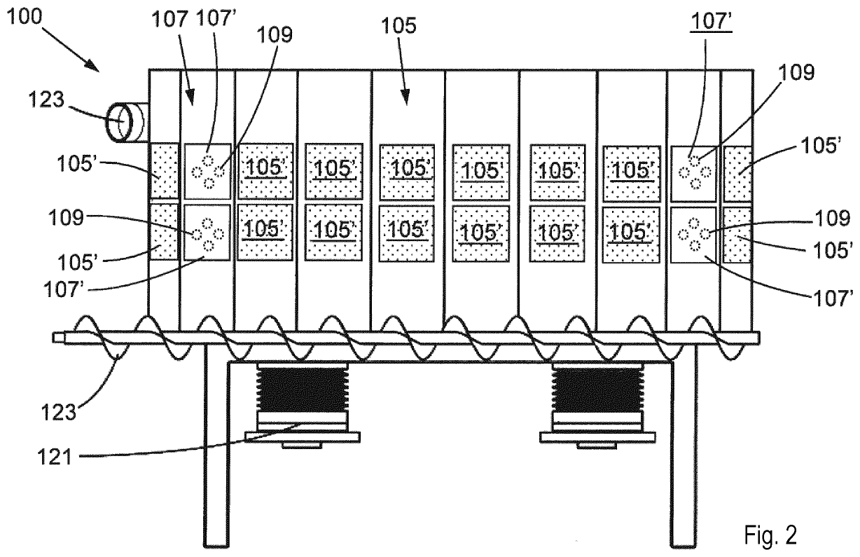

FIG. 2 shows a side view of the apparatus of FIG. 1.

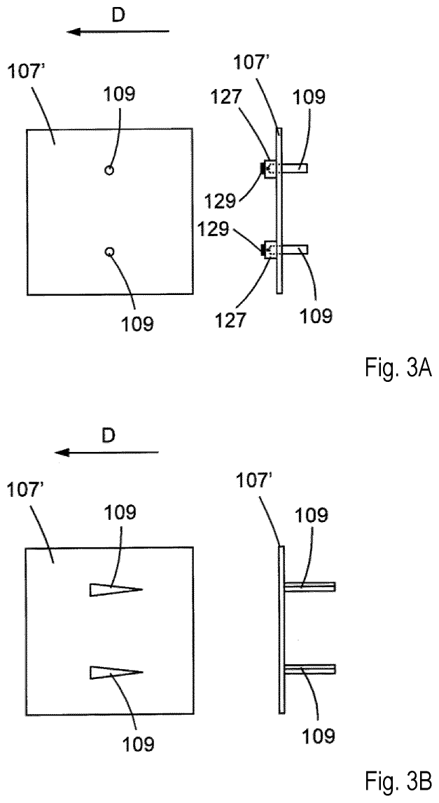

FIGS. 3A and 3B show different embodiments of an unravelling section.

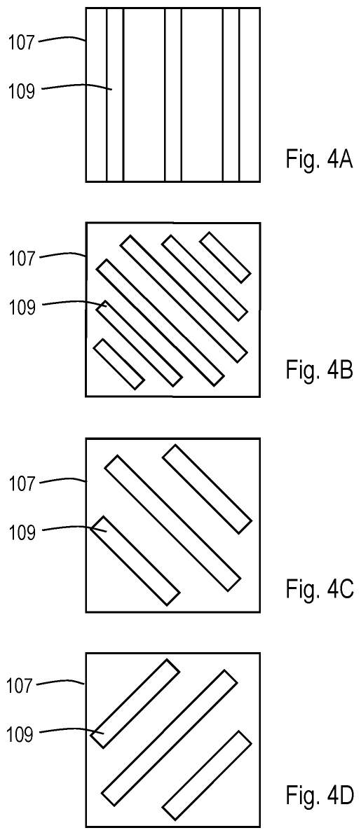

FIG. 4A through D show different arrangements for protrusions.

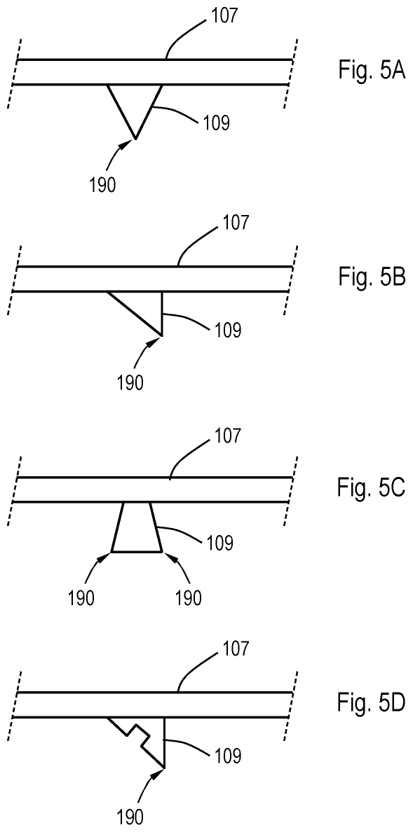

FIG. 5A through D show different forms of protrusions with a sharp edge.

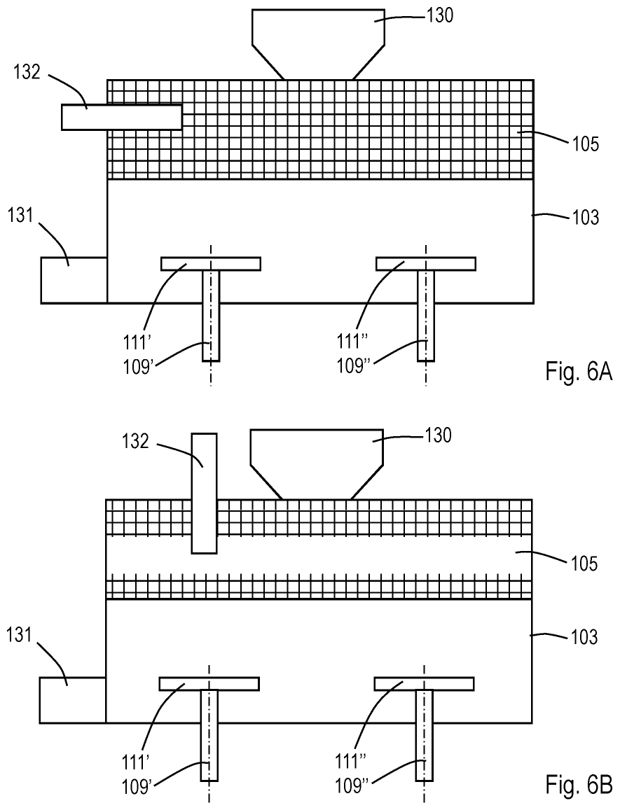

FIGS. 6A and B show side views of two apparatuses with partly closed upright walls.

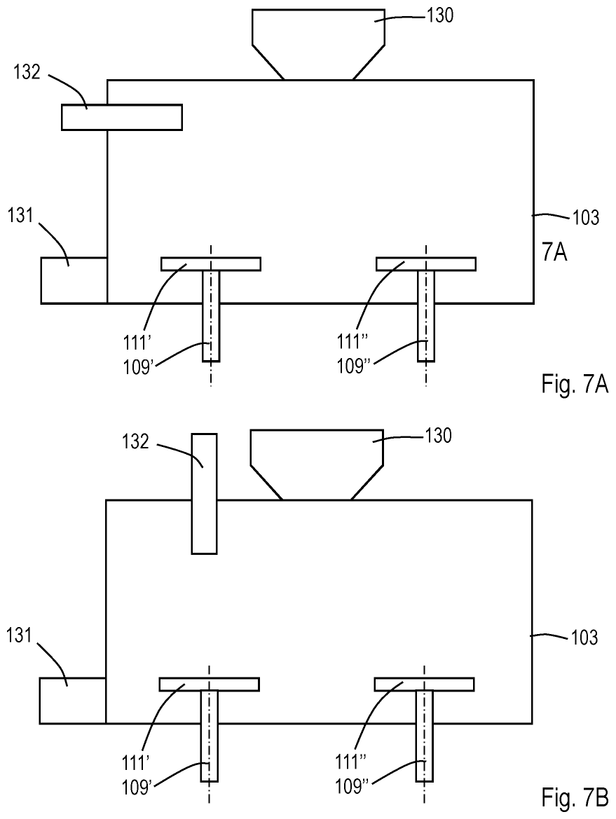

FIGS. 7A and B show side views of two apparatuses with completely closed upright walls.

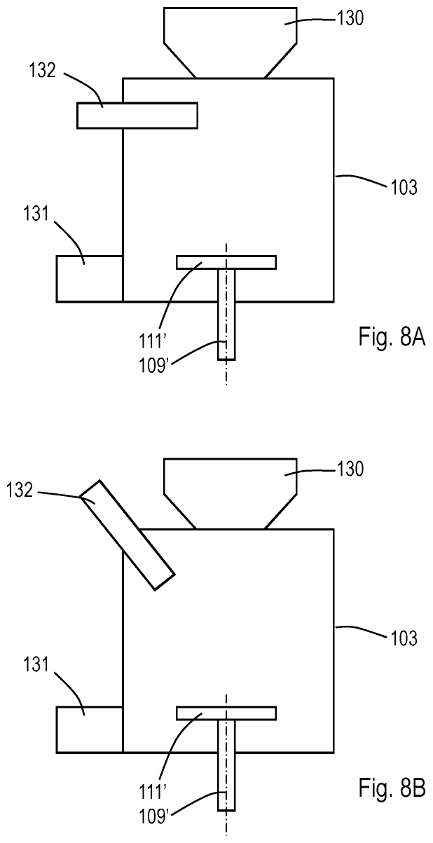

FIGS. 8A and B shows side views of two mono crank apparatuses with completely closed upright walls.

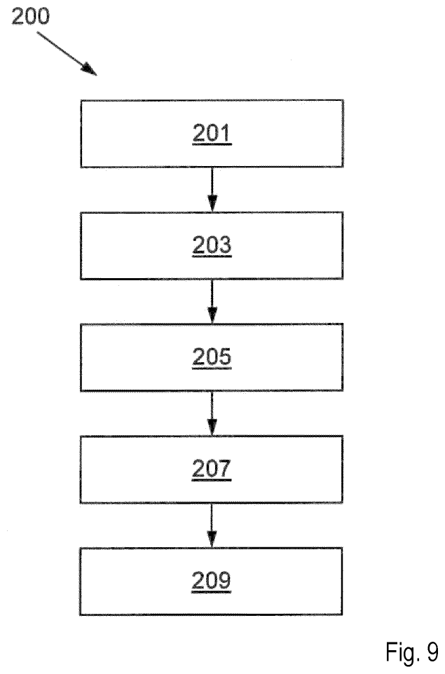

FIG. 9 shows an embodiment of a method of processing a carpet product.

Example 1 describes various tests for processing a carpet product.

### FIGS. 1 to 9

FIGS. 1 and 2 show a top view and side view respectively, of an embodiment of an apparatus 100 for processing a waste carpet product. The basic arrangement is known from EP 3816345 and comprises a container 101 comprising an upright wall 103, in this particular embodiment provided with a sieve arrangement 105 positioned in the circumference of two rotary cranks 111′, 111″. The sieve arrangement 105 comprises sieve sections 105′ provided with sieves with a mesh diameter of for example 2 mm, which are selected depending on the type of carpet product to be processed (cut pile or loop pile, length of face yarns, type of backing material, type of primary backing etc.). The sieve sections 105′ are distributed over the upright wall 103 and disposed at an inclination angle of 4 degrees with respect to the circumference direction of the container 101. Each sieve section 105′ comprises a downstream part, downstream to the airflow direction D, and an upstream part, upstream to the airflow direction D, wherein the downstream edge of the respective sieve section extends more into the inside of the container 103 than the upstream edge of the respective sieve section 105′.

The upright wall 103 further comprises an unravelling arrangement 107 positioned in the circumference of the two rotary cranks 111′, 111″. The unravelling arrangement 107 comprises unravelling sections 107′ provided with protrusions 109. The type, length and pattern of the protrusion 109 on a respective unravelling section 107′ is also dependent on the type of carpet product to be processed. In this embodiment, the protrusions 109 are cylindrical shaped metal rods of length 20 mm extending into the inside of the container 101, arranged in a matrix pattern.

The sieve section 105′ and the unravelling section 107′ are provided in or on a metal wall plate of dimensions 200×200 mm, and are removably attached to the upright wall 103. Both the sieve section 105′ and the unravelling section 107′ can easily be replaced or reordered, dependent on the type of waste object to be processed. Furthermore, the protrusions are removably connected to the unravelling sections and the length of the protrusions is adjustable.

A portion of waste objects (such as coarsely shredded broadloom carpet) is supplied, either continuously or phased, via the upper part of the container 101 to the lower part of the container 101, for example using one or more conveyor belts located above theca container 101. The pieces of carpets are pre-cut in pieces of approximately 0.1 to 0.5 m2 , such that the pieces of carpet can easily be supplied to the apparatus 100. The carpets comprise an upper layer of cut pile face yarns, securely connected using a secondary (heavy weight) like a bituminous backing or a rubber layer embedding the lower part of the yarns (facing away from the upper surface), stitched in a textile sheeting used as primary backing. If post-consumer carpet product is processed, the product may comprise impurities, such as dust, or even small stones, metal components, and plastic foil.

The container 101 is provided with two upright shafts 109′, 109″. A first upright shaft 109′ is provided with a rotary crank 111′ having distal ends 113′. A second upright shaft 109″ is provided with a rotary crank 111″ having distal end 113″. The distal ends 113′, 113″ comprise a fixed crank element and disposable shredding tips or shredding knives. The upright shafts 109′, 109″ are driven by motors 121, and are both rotating in the same direction, in this embodiment counterclockwise as seen from above, thereby defining an airflow direction D at the circumference of the upper wall 103. The distal ends 113′, 113″ of two rotary arms 111′, 111″ simultaneously pass a line extending between the two upright shafts 109′, 109″ for ripping apart the pieces of carpets, introduced into the lower part of the container 101, into a ripped portion of carpets. Both rotary cranks 111′, 111″ define a rotational volume. Two upright air guiding elements 115 are provided above the said rotational volumes of the rotary cranks 111′, 111″. The upright air guiding elements 115 have a conical profile with rounded ends in order to prevent material from sticking to the upright air guiding element 115 instead of being discharged from the container 101. The upright air guiding element 115 defines in cooperation with said upright wall 103 a passage 117 for air along the upright wall 103, which passage 117 tapers in the airflow direction D.

The ripped portion of carpets are slung, by the two rotary cranks 111′, 111″, against the sieve arrangement 105 and the unravelling arrangement 107. Fibers that are already separated from the carpets are slung through the sieve openings of the sieve arrangement 105 and are discharged by screw conveyors 123. Pieces of carpets from which the fibers have not yet been separated, are slung against the protrusions 107′ of the unravelling arrangement 107, for further unravelling of the fibers from the carpets.

The unravelled ripped portion of carpets is further ripped apart by subjecting the unravelled ripped portion of carpets in between the two rotary cranks 111′, 111″ and by slinging the unravelled ripped portion of carpets, by the two rotary cranks 111′, 111″, against the unravelling arrangement 107, thereby ripping and unravelling the unravelled ripped portion of carpets in smaller portions and separating the fibres (the yarns) from the carpets. The upright air guiding element 115 guides the unravelled ripped portion of carpets towards the sieve arrangement 105 and the unravelling arrangement, wherein eventually the fibres are separated from the carpets and are slung through the sieve openings of the sieve arrangement 105.

Materials of high specific weight, in particular the backing, stones and metal components, remain at the bottom of the container 101 and can be discharged from the container 101 after finishing the process of processing the waste objects. IN an alternative embodiment, the bottom can be cleared form these materials using a suction arrangement as will be explained in the further examples. Materials of low specific weight, in particular plastic foil, swirls up in the container 101 due to the thermal turbulence generated by the two rotary cranks 111′, 111″ and by heat generated in the container 101 and can be discharged from the upper part of the container 101 using air pump 125.

FIG. 3A shows an embodiment of an unravelling section, comprising two cylindrically shaped metal rods 109, adjustable attached to the metal plate of the unravelling section 107′. The two rods are adjustable in length by a rod receiving arrangement 127. By rotating screw 129 clockwise, the rod 109 is displaced inside the rod receiving arrangement 127, thereby reducing the length of the rod 109 extending into the inside of the container 101. By rotating the screw 129 counterclockwise, the rod 109 is displaced outside the rod receiving arrangement 127, thereby increasing the length of the rod 109 extending into the inside of the container 101.

FIG. 3B shows another embodiment of an unravelling section, comprising two knives 109 with a cutting edge, extending into the inside of the container 101, wherein the cutting edge of the knife 109 is positioned upstream of the airflow D and arranged for receiving the ripped portion of waste objects, for unravelling the ripped portion of waste objects by cutting the ripped portion of waste objects into smaller components.

FIG. 4A through D show various unravelling sections 107 with different arrangements for protrusions 109. In FIG. 4A the protrusions are in the form of elongated triangles (see FIG. 5A) with a sharpened upper edge, which run in parallel in vertical direction. The protrusions in FIG. 4B are smaller elongated triangles (see FIG. 5B for their form) arranged in an inclined direction. The protrusions of FIG. 4C (see FIG. 5C for their form) are inclined in a different direction when compared with FIG. 4B. Those of FIG. 5D run in the same upward direction as the protrusions of FIG. 4B, but are however longer (see FIG. 5D for their form).

FIG. 5A through D show the different forms of the protrusions of FIG. 4, each protrusion having at least one sharp edge 190. The figures are top views of the elongated protrusion in their length direction (this way showing cross sections of each of the protrusions 109 as present on sections 107). FIG. 5C shows a protrusion with two sharp edges 190.

FIGS. 6A and B show side views of two apparatuses 100 with partly closed upright walls 103. Also, a hopper 130 is shown in each case, for feeding carpet product to the central container. In FIG. 6A the upper section of wall 103 has sieve sections 105. The lower part of the wall is closed and therewith impermeable impermeable for the yarn containing (first) fraction. This yarn containing fraction removed from the container by using suction unit 132. The second fraction containing the heavy backing particles remains on the bottom of the apparatus and is removed by suction unit 131. FIG. 6B shows an apparatus 100 that is in essence the same as that of FIG. 6A, albeit that the suction unit 132 now emerges from the top, instead of a side wall 103.

FIGS. 7A and B show side views of two apparatuses with completely closed upright walls. These apparatuses are in fact almost the same as those depicted in FIGS. 6A and 6B, differing only in that the upright walls 103 are completely closed, thus impermeable over their entire height for the first fraction containing the yarns of the processed carpet.

FIGS. 8A and B shows side views of two mono crank apparatuses with completely closed upright walls, comparable to the apparatus as shown in FIGS. 7A and 7B.

The apparatuses of FIG. 8A and B differ in that these are mono crank apparatuses. Although still suitable for processing carpet products, the pieces of carpets that are fed via hopper 130 preferably have relatively small dimensions (e.g. between 2-5 cm in length) in order to keep the time needed to process the products low.

FIG. 9 shows an embodiment of a method 200 of processing a waste carpet product according to the second aspect of the present disclosure. The method 200 of processing the carpet product uses the apparatus 100 as described above with regard to FIG. 7B and comprises the steps of providing pieces of said waste carpet (having dimensions of about 15×15 cm) to the container 101 in step 201 via hopper 130. Then, in step 203, ripping apart the pieces of carpet into a ripped portion of carpet having smaller dimensions, by subjecting the carpet portions in between the two rotary cranks 111′, 111″. Then, in step 205, unravelling the ripped portion of waste carpet into the unravelled ripped portion of said carpet, by the unravelling arrangement 107. And then in step 207, separating a first stream (i.e. a first fraction) from the unravelled ripped portion of waste objects, wherein the first stream comprises at least part of the face yarns of the carpet, by sucking this light fraction trough suction unit 132. Next in step 209, separating a second stream of materials of high specific weight (i.e. the second fraction), by sucking this heavy fraction form the bottom through suction unit 131.

### Example 1

Several tests have been run to separate the textile (yarn) part from the rubber part from an industrial dust control mat. These mats are extremely difficult to recycle due to the embedding of yarns into a heavy rubber, and thus, the recycling thereof represents in fact a worse-case scenario in the field of recycling carpet products.

The dust control mat used for the experiments comprised as a primary backing a textile sheeting of non-woven PET (polyester), a cut pile of nylon yarns, and a rubber secondary backing embedding the primary backing and the pile yarns stitched therein by tufting. The rubber layer of the mat is a relatively dense layer having a weight of about 1.65 kg/m2, which was made using a standard vulcanized Nitrile-Rubber compound (about 50% NBR rubber, 35% carbon black and 15% plasticizers, Zinc Oxide and other components). The primary backing was a 125 g/m2 non-woven PET sheeting, having tufted therein a nylon 675 g/m2 cut pile of the velour type. This means that about 67% of the dust control mats was made out of the rubber compound, while the textile part was the remaining 33%.

The quality of the separation process was evaluated by the measurement of the weight of the textile part separated and freed from the rubber by the processing in the unravelling apparatus. This was rated in the different output streams, from the suction units and from the sieves. Finally, also the part remaining inside the central container (also referred to as the “chamber”) was evaluated accordingly. In case some rubber pieces were also present in the fraction containing the yarns (also referred to as the “textile fluff”), a post unravelling separation was performed using a state-of-the art cyclone to evaluate the quality of the test.

The final evaluation of the quality of the separation was done by calculating the total textile part (pile and primary backing) removed from the rubber substrate. On top, also the presence of rubber pieces inside the released textile fluff was also observed and indicated as a non-positive result.

The machine used was highly similar to the machine as disclosed in EP3816345 (manufactured by NewWave Engineering BV, Echt, The Netherlands), as shown here above in FIG. 1, and consisted of two cranks, rotating both anticlockwise with a frequency of 50 Hz. The rotating parts had a L shape. As an unravelling arrangement, multiple steel bars (see FIG. 1), having different shape, were welded on its surface in the area in front of the rotating shafts. Experiments were run with sieves (also denoted as “grids”) being present (as indicated in FIG. 1), and in the alternative with closed container walls, impermeable for the textile fluff fraction.

In the set-up with two rotating cranks, the mats were fed without any pre-shredding. The processing cycle consisted of the following steps:
1. Introduction of 15 kg of the dust control mats into the chamber from an opening on the top of the chamber, using a low rotation speed for the two shafts (30 Hz).
2. Closure of the opening at the top of the chamber, increase of the rotation speed up to 60 Hz, starting fluff suction from the side unit (see FIG. 6A) for 240 sec.
3. Slowing down engine rotation speed and opening of the side door to remove material left inside.

This way, a series of tests was done as follows:
Tests using the machine described by Patent EP3816345, containing a full set of grids on the chamber wall. In the different tests different mash sizes for the grid have been tested.
Tests without any grids on the wall (the wall being completely closed), having a top suction unit for removing the textile fluff fraction and a bottom suction unit for removing the fraction containing the dense rubber parts.
In the tests with the closed wall, variations with the positioning the top suction unit was performed, differing in the vertical position (height) in the chamber, and lateral position.

The results indicated that in the set-up using the grids, hardly independent on the mesh size of the sieves (5, 10 and 15 mesh), about 50-55% of the textile yarns could be separated out of the mats, however, with some severe disadvantages: part of the textile fluff clogs the sieves, and thus, the chamber needed to opened to remove the textile fluff. Also, the fraction with the textile fluff comprises small rubber particles that needed to be removed via an extra cyclone treatment of the textile fluff fraction.

In the set-up with the closed wall and suction openings in the top and/or side wall of the chamber, about 80% of the textile yarns could be separated out of the mats. This was hardly dependent on the number (one or two) or position (top, side or top and side wall) of the suction opening. However, still some rubber particles were present in the textile fluff fraction, needing a post treatment.

In the set-up with suction tubes extending into the chamber the best results were obtained, viz. about 90% of the textile yarns being separated out of the mats and no rubber particles being present in the textile fluff fraction.

What is claimed is:

1. A method for processing a carpet product comprising face yarns and a backing material embedding a lower portion of the face yarns, using an apparatus comprising a container for receiving at least a portion of said carpet product, said container comprising a bottom wall and a top wall connected by an upright wall and at least one rotary crank positioned in said container, wherein said upright wall comprises an unravelling arrangement positioned in the circumference of said rotary crank, the unravelling arrangement comprising protrusions provided on said upright wall extending into the inside of said container from said wall towards said rotary crank, the method comprising the steps of:
feeding the at least a portion of said carpet product into the container, and
rotating the rotary crank to induce that the at least a portion of the carpet product travels along the protrusions for unravelling said carpet product in a first fraction comprising at least part of the face yarns and a second fraction comprising at least part of the backing material.

2. A method according to claim 1, wherein the wall is impermeable for the first fraction at least adjacent the rotary crank.

3. A method according to claim 1, wherein the wall is impermeable for the first fraction.

4. A method according to claim 1, wherein the protrusions extend into the container over a length of between one of:
2 and 50 mm,
5 and 30 mm, and
10 and 20 mm.

5. A method according to claim 1, further comprising the step of removing the first fraction from the container by using a first suction unit having an entrance opening that is provided above the rotary crank, by sucking air comprising the first fraction through an entrance opening of the first suction unit, thereby removing the first fraction from the container.

6. A method according to claim 5, wherein the entrance opening of the suction unit is at an end of a suction tube that extends from a wall of the chamber towards a center thereof.

7. A method according to claim 1, further comprising the step of removing the second fraction from the container by using a second suction unit having an entrance opening below the rotary crank, by sucking air comprising the second fraction through the entrance opening of the second suction unit, thereby removing the second fraction from the container.

8. A method according to claim 1, wherein the protrusions comprise a cutting arrangement, with a cutting edge, and further comprising the step of unravelling the carpet product by cutting the carpet product while travelling along the cutting arrangement.

9. A method according to claim 1, wherein said protrusions are arranged in a row, one of:
perpendicular to a circumference direction of said container,
parallel to the circumference direction of said container,
both perpendicular and parallel to the circumference, and
inclined to the circumference, and
wherein said protrusions are arranged equidistant from each other.

10. A method according to claim 1, wherein said unravelling arrangement is provided in said upright wall at a height of said upright wall, at least substantially, between one of:
¼ and ¾ of the height of said upright wall, and
⅓ and ⅔ of the height of said upright wall.

11. A method according to claim 1, wherein while rotating the rotary crank passes the protrusions at a distance in the range of between one of:
0.5 cm and 25 cm,
1 cm and 20 cm, and
2 cm and 15 cm.

12. A method according to claim 1, wherein the rotary crank is in essence flat to minimize turbulence at the bottom of the container.

13. A method according to claim 1, wherein in the container, two said rotary cranks are positioned that are rotated in the same plane.

14. A method according to claim 13, wherein the rotary cranks rotate in the same direction.

15. A method according to claim 1, wherein each protrusion in essence has the same distance to the rotary crank facing the said protrusion.

16. A method according to claim 1, wherein the process is performed semi-continuously.

17. A method according to claim 1, further comprising the step of feeding the carpet product while having a humidity of at most 40 wt %.

18. A method according to claim 1, further comprising the step of feeding the carpet product having a longest dimension of one of:
at most 25 cm,
20 cm,
15 cm,
14 cm,
13 cm,
12 cm,
11 cm,
10 cm and
less than 10 cm.

19. A method according to claim 1, wherein the carpet product is a cut pile carpet product.
